(19) United States
(12) Patent Application Publication
(10) Pub. No.: US 2012/0279377 A1
(43) Pub. Date: Nov. 8, 2012

(54) CONVERTIBLE TRANSFORMING DRUM SET

(76) Inventor: David E. Moody, Huntington Beach, CA (US)

(21) Appl. No.: 13/466,098

(22) Filed: May 7, 2012

Related U.S. Application Data
(60) Provisional application No. 61/483,120, filed on May 6, 2011.

(51) Int. Cl. G10D 13/02

(52) U.S. Cl. 84/421

(57) ABSTRACT

A convertible drum set is disclosed in the present invention. Said convertible drum set comprises modular sectional drums, quick attach and release mounts and attachment components. Said drum set can be converted into several permutations, for example upright cocktail drum set configuration or conventional horizontal configuration, used in different musical applications and venues.

### REFERENCE TO RELATED APPLICATIONS

This patent application claims the benefit of U.S. Provisional Application No. 61/483,120 filed on May 6, 2011, the disclosure of which is incorporated herein by reference in its entirety.

### BACKGROUND OF THE INVENTION

1. Field of the Invention

The present invention relates to a musical instrument, drum set. More particularly, the present invention relates to a convertible drum set that can be converted into several permutations used in different musical applications and venues.

A drum set is a collection of drums and other percussion instruments set up to be played by a single player. A drum set usually includes bass drums, snare drums, tom drums and cymbals. A drummer commonly has two major options for setting his/her drum set: a upright or cocktail drum set configuration, or a conventional horizontal drum set configuration. The cocktail set configuration uses a vertical bass drum with side attached tom drum(s) and snare drum. The cocktail set is designed for standing while playing due to vertical bass drum and may only be needed occasionally due to restricted floor space requirements and ease of transportation. The cocktail drum set configuration is a popular choice for drummers playing small venues and lounges where floor space is restricted and also when the drummer wants more visibility to the audience. The cocktail or upright drum set configuration also allows the musician to easily switch to another instrument if desired such as guitar, trumpet or any other instrument that is localized and needing quick access since drummer is already in standing position. However, a drummer will generally need a horizontal conventional configuration for added performance, more drums in setup, traditional look, sitting position and added range of motion to play.

For the purpose of setting up a drum set, it is common that a drum has at least one mounting member permanently attached to a portion of the drum. These mounting members may be attached at various locations on the drum. These mounting members in turn attach, permanently or temporarily, to other support assemblies. This attachment ultimately provides for rigid restriction of the drum in a desired configuration.

It is desirable to have a drum set that can be easily set up and change from one configuration to another configuration. Such drum set not only provides the flexibility of configuration for different purpose and floor spaces, but also provides ease of transportation and prevention from buying multiple drum sets for different configuration needs.

2. Description of Related Art

Some related prior inventions are disclosed as prior art herein. More specifically, by way of example, U.S. Pat. No. 4,593,596 discloses a portable drum set which utilizes pre-tuned drum head and which has no shells as much. The main objective of this invention is to produce a portable drum set that may be easily carried and set up while reducing the space needed for setting up and storage. U.S. Pat. No. 5,977,464 discloses a drum support system, in which various holders are provided to retain tom drums in a playable position on a horizontally oriented surface. Adjustment parts are also provided with the holders for various dimension tom drums.

### SUMMARY OF THE INVENTION

In an exemplary embodiment of the present invention, there is disclosed a convertible drum set, comprising modular, sectional drums with quick attach and release mounts and attachment components. The drum set can be made from any traditional building materials such as wood or synthetic shell materials. By using modular cuts in shells and attaching together with quick attach and release mounts, said drum set can easily convert to several styles and designs from upright cocktail drum set to other traditional and unique drum setups.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a frontal exploded view drawing of cocktail setup example and the mechanisms and concept for convertible drums

FIG. 2 is a an isolated exploded view drawing of bass drum and mechanisms used.

FIG. 3 is an example of cocktail setup configuration.

FIG. 4 is an example of a traditional horizontal configuration.

### DESCRIPTION OF THE PREFERRED EMBODIMENT

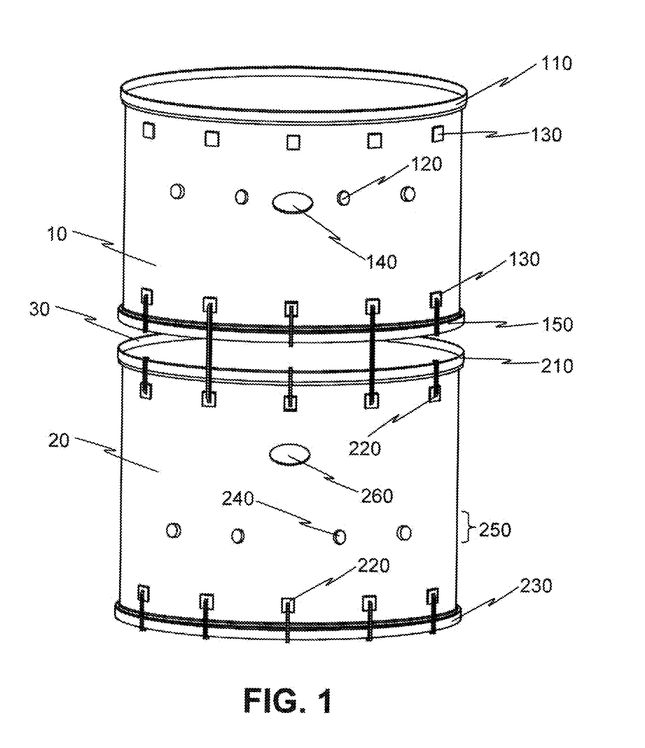

Referring to FIG. 1, there is disclosed a convertible drum set, comprising modular, sectional drums with quick attach and release mounts and attachment components. The drum set can be made from any traditional building materials such as wood or synthetic shell materials. By using modular cuts in shells and attaching together with quick attach and release mounts, said drum set can easily convert to several styles and designs from upright cocktail drum set to other traditional and unique drum setups.

In the preferable example of modular, sectional bass drums as shown in FIG. 1, the top and bottom of cocktail setup bass drum are two modular, sectional drums. The top portion of cocktail setup bass drum 10 is cut at a predetermined depth 30 and attached to bottom portion of bass drum 20. Top portion of cocktail setup bass drum 10 includes quick attach and release mounts 130; top and bottom tom rim and drum head, 110 and 150; floor tom leg mounts 120 and receptacles 140 for attachment components. The bottom portion of cocktail setup bass drum includes quick attach and release mounts 220, top and bottom bass hoop and drum head; floor tom leg mounts 240; a bass spur mount 250; and receptacles 260 for attachment components.

Top section of bass drum can be separated from bottom and converted to a floor tom drum. Bottom section of the cocktail setup bass drum can be detached with quick attach and release mounts and converted to a smaller upright bass drum or transformed into a conventional, horizontal setup bass drum. Attachment components can be either permanently mounted on said drum or separated from said drum. Attachment components can vary to achieve the objective of converting drums from cocktail setup to standard horizontal drum setup. For example, attachment components can be attached to or removed from receptacles 140 or 260 and easily positioned for cocktail drum setup or standard drum setup by allowing pre-mounted drums to transfer in whole to an entirely different placement without the need to re-mount drums. Floor leg mounts on both top and bottom portion of cocktail setup bass drum, 120 and 240, are installed to accommodate floor tom legs. The top portion drum can be converted to a floor tom with mounts and legs. Bottom cocktail drum setup bass drum has mounts 250 installed to accept bass drum spurs thus allowing fast conversion to horizontal setup bass drum. The bottom portion also includes receptacle 260 for attachment components that accept pre-mounted tom drums or snare drum to be placed in horizontal bass drum position thus allowing for tom drums to mount in traditional drum setup.

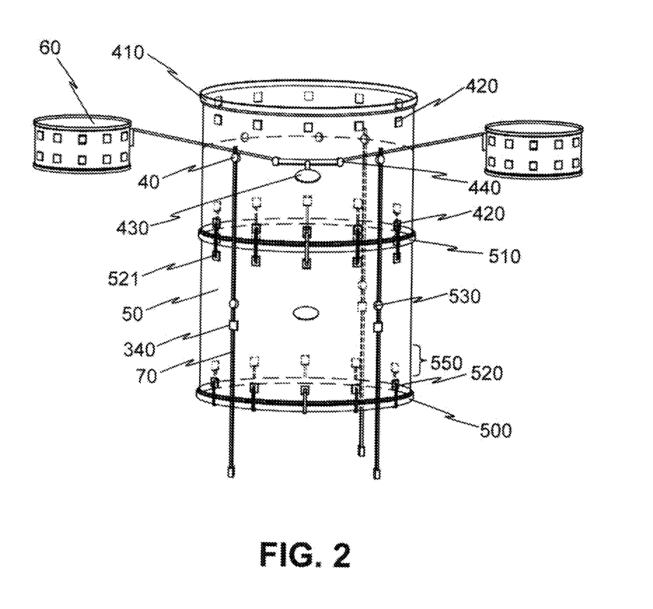

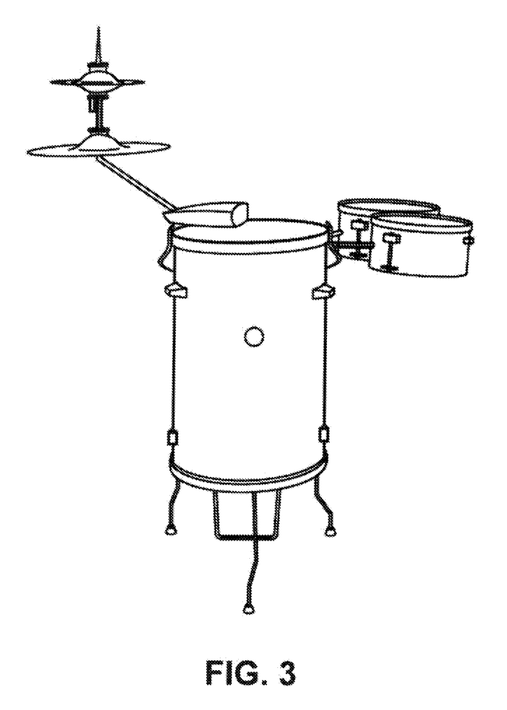

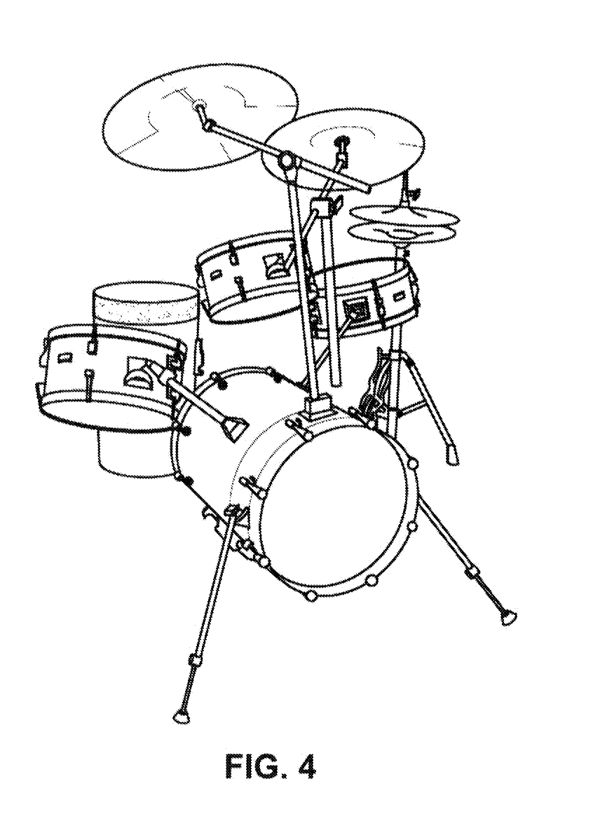

Said drum set can be made from any traditional building materials such as wood or synthetic shell materials. The structure is designed for optimum flexibility of setup using popular size drum shells for most musical applications. In the particular example of upright bass drum shown in FIG. 2, the top portion 40 of cocktail setup bass drum is measured 18 inches by 10 inches (though not limited to this size). The top portion drum 40 includes top and bottom rims and drum heads 410 and 460, quick attach and release mounts 420, along with mounts for multiple setups including floor tom leg mounts 450, receptacles 430. Drums and mounts and attachment components may be made from alternative materials. The bottom portion is measured to 18 inches by 14 inches (not restricted to this size). The bottom portion drum 50 includes top and bottom rims and drum heads 510 and 560, quick attach and release mounts 520, along with mounts for multiple setups including floor tom leg mounts 540, receptacles 530 and bass drum spur mount 550. The top and bottom portion are attached together through quick attach and release mounts on both portion to form an upright cocktail setup bass drum. Floor legs 70 are installed through floor tom mounts 450 and 540. In FIG. 2, it also shows attachment components 440 are attached to receptacles 430 on the top portion for the attachment of additional snare drum or tom drums on the upright cocktail setup bass drum. The top and bottom portion can be connected together and played in a standard horizontal setup. As discussed above, the top portion may be separated into two distinctly different drums with top portion covered to floor tom and bottom portion used as bass drum. FIG. 3 shows a exemplary setup of a convertible drum set in an upright cocktail configuration. Viewing FIG. 4 shows a traditional horizontal configuration for comparison to the convertible drum setup depicted in FIG. 3.

Additional drum mounts may be added to attach more drums such as additional tom drums mounted in either cocktail drum setup or standard horizontal drum setup. Drum shells can be attached as in primary design wherein one drum can be cut into sections and used in whole or separated and be used individually. With said convertible drum set, virtually any drum can be modularly connected in sections using drum in fully connected setup or detaching modular portions of drum to convert to other drum set usage. Alternatively, modular sectional drums may be attached together without bottom drum head installed. This alternate method would attach drum shells flush to each other since they would not have bottom heads installed, thus having a more uniform look in attached position. In the present invention, larger drums can be sectioned into more than two sub shells. For example, bass shell can be three sections creating sub drums such as floor tom, rack tom and single bass drum. Another alternative design is to connect non-matching shell diameters with connectors, for example in a bass sub-woofer systems where one smaller drum is attached to a larger bass drum to accentuated bass tone and frequencies.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A convertible drum set comprising:
a. modular, sectional drums;
b. quick attach and release mounts; and
c. attachment components.

2. A convertible drum set of claim 1, wherein said modular, sectional drums are made from any traditional building materials, including but not limited to, wood or synthetic shell materials.

3. A convertible drum set of claim 1, wherein said modular, sectional drums is any popular size drum shells.

4. A convertible drum set of claim 1, wherein said attachment components are made from any traditional materials, including but not limited to, metal, plastic or other similar materials. Said attachment components are either pre-mounted on said modular sectional drums or separated from said modular sectional drums.

5. A method of configuration of a convertible drum set, comprising:
a. deploy a convertible drum set comprising:
i. modular, sectional drums;
ii. quick attach and release mounts; and
iii. attachment components
b. attach modular, sectional drums through said quick attach and release mounts to form large drums, or use modular sectional drums separately;
c. assemble attached or/and separated modular sectional drums into desired configuration using attachment components.
